(19) United States
(12) Patent Application Publication
(10) Pub. No.: US 2009/0127265 A1
(43) Pub. Date: May 21, 2009

(54) LIQUID RECEPTACLE FOR A VEHICLE

(75) Inventors: Martin Magnusson, Goteborg (SE); Hans Adlersson, Askim (SE); Bengt Henstrom, Alingsas (SE); Magnus Bernhardsson, Goteborg (SE); Anders Ivarsson, Torslanda (SE); Sigurd Sonderegger, Askim (SE); Hans Nordstrom, Goteborg (SE)

Correspondence Address: WRB-IP LLP, 1217 KING STREET, ALEXANDRIA, VA, 22314, US

(73) Assignee: VOLVO LASTVAGNAR AB, Goteborg (SE)

(21) Appl. No.: 12/296,673

(22) PCT Filed: Apr. 27, 2007
(86) PCT No.: PCT/SE2007/000417

§ 371 Date: Oct. 10, 2008

(30) Foreign Application Priority Data
Apr. 27, 2006 (SE) 0600954-2

(51) Int. Cl. B65D 88/12; B60K 15/073; F01N 3/00

(52) U.S. Cl. 220/564; 210/416.4

(57) ABSTRACT

A liquid receptacle for a vehicle includes a first unit having a space for containing a liquid and a second unit which is attached to the first unit. The second unit includes a housing which housing accommodates a pump for conveying liquid out from the first unit and a filter for filtering the liquid to be conveyed.

### BACKGROUND AND SUMMARY

The invention relates to a liquid receptacle for a vehicle.

In order to reduce the pollutants contained in the exhaust gas of an internal-combustion engine, in particular the nitrogen oxides, the principle of the regulated or controlled diesel catalytic converter (CDC) has proved advantageous. That procedure is used primarily in internal-combustion engines which are operated with an excess of air, such as, for example, diesel engines and lean-running engines. The procedure, which is based essentially on the method of selective catalytic reduction (SCR) is known. In the case of the SCR method, the nitrogen oxides, together with ammonia, are brought into contact with a selective catalyst and catalytically converted into environmentally safe nitrogen and water.

Due to the danger associated with the use of ammonia, namely the toxicity, and because of the unpleasant smell caused by ammonia, ammonia in its pure form is not carried in the motor vehicle in the case of an internal-combustion engine equipped with a CDC system. Instead of ammonia, an aqueous urea solution is carried in the motor vehicle as a reducing agent for the catalytic conversion of the nitrogen oxides. Ammonia is always produced from the aqueous urea solution by hydrolysis in the exact quantity instantaneously required to convert the nitrogen oxides.

A common urea solution used for this purpose is AdBlue®. In the subsequent text, the term “urea” will be used for any suitable aqueous urea solution. A serious disadvantage of those aqueous solutions is that there is a danger of freezing at certain temperatures as a function of the concentration of the dissolved substance.

The simple addition of antifreeze is not possible because no antifreeze is known for such aqueous solutions, which effects an appreciable lowering of the freezing point in economical doses. Moreover, if an additional substance, such as antifreeze, is used in conjunction with the use of a reducing agent in the exhaust-gas purification system, undesirable by-products which are emitted along with the exhaust gas can be produced. For that reason, antifreezes cannot be used for this purpose in exhaust-gas purification processes.

In addition to the freezing problem, usually on heavy vehicles, such as trucks and buses, the space available for arranging components on the frame is very limited. Introducing new components such as a urea tank together with equipment for transportation of urea, i.e. pumps, filters, conduits, hoses, valves etc. is therefore difficult. Furthermore, it has to be ensured that also the additional equipment is not freezing. The use of electrical equipment for controlling pumps and valves, and heating means for heating the pump, filter and hoses will result in further packaging problems.

It is desirable to provide a liquid receptacle for a vehicle of the kind referred to in the introduction, which liquid receptacle is able to reduce the packaging problem associated with prior art liquid receptacles and the requisite additional equipment used together with such liquid receptacles.

By the provision of a liquid receptacle for a vehicle which comprises a first unit having a space for containing a liquid and a second unit which is attached to the first unit, wherein the second unit comprises a housing which accommodates a pump for conveying liquid out from the first unit and preferably a filter for filtering the liquid to be conveyed, the liquid space and the pump, and the filter if present, can be arranged in the close vicinity to each other, and the length of any conduits or hoses arranged between the

current components can be decreased. Hereby, the risk for leakage can be reduced. Reduced length of conduits and hoses also implies decreased costs. Furthermore, since the first unit can be used as a bracket for the pump and/or the filter, the number of components and the requisite packaging space on the frame can be reduced. The number of attachment points on the frame can also be reduced, and the mounting of the components on the vehicle can be facilitated.

If the liquid in the receptacle and the components used for transportation of the liquid have to be heated so as to avoid freezing thereof, the liquid receptacle according to the invention has a great advantage in that the heating can be accomplished in an effective way. The compact solution requires a relatively short heating circuit and one and the same circuit can be used for heating the liquid in the first unit as well as the pump and/or the filter. Furthermore, the liquid receptacle according to the invention is particularly suitable to be heated by means of a liquid heating medium, such as an engine coolant. Such a solution will reduce the consumption of electricity and the costs compared to a system where each component is separately arranged on the frame and heated electrically.

The invention also relates to a vehicle, particularly a truck, provided with a liquid receptacle according to the invention.

Further advantages and preferred embodiments of the invention are disclosed in the following description.

### BRIEF DESCRIPTION OF DRAWINGS

With reference to the appended drawings, below follows a more detailed description of embodiments of the invention cited as examples.

In the drawings:

FIG. 1 is a schematic sectional view of a liquid receptacle according to the invention,

FIG. 2 is a schematic illustration of a variant of the liquid receptacle according to the invention,

FIG. 3 is a schematic illustration of a further variant of the liquid receptacle according to the invention,

FIG. 4 is a schematic illustration of a further variant of the liquid receptacle according to the invention,

FIG. 5 is a schematic illustration of a further variant of the liquid receptacle according to the invention,

FIG. 6 is a schematic illustration of a further variant of the liquid receptacle according to the invention,

FIG. 7 is a schematic illustration of a further variant of the liquid receptacle according to the invention,

FIG. 8 is an illustration of a heavy vehicle provided with a liquid receptacle according to the invention,

FIG. 9 is an illustration of a heavy vehicle provided with a liquid receptacle according to the invention, which receptacle is arranged in an alternative position, and

FIG. 10 is a plan view of the heavy vehicle illustrated in FIG. 9.

### DETAILED DESCRIPTION

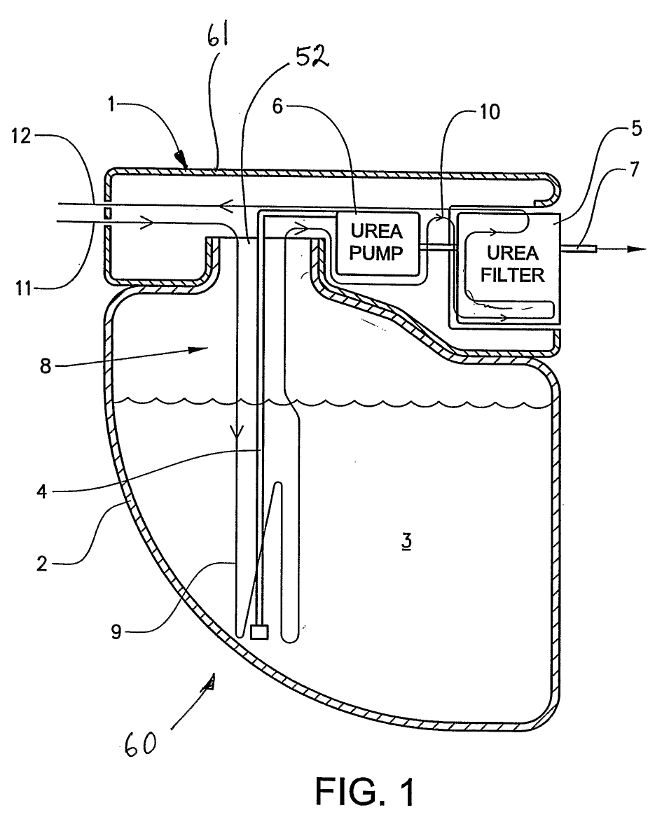

In FIG. 1 a liquid receptacle 60 for a vehicle according to the invention is schematically illustrated. The liquid receptacle is preferably a tank to be arranged on a vehicle for providing an agent, such as urea, for use in purification of the exhaust of an engine of the vehicle. The liquid receptacle has a first unit 2 with a space for containing a liquid 3 inside the first unit 2 and a second unit 1 which is attached to the first unit 2. The second unit 1 comprises a housing 61 which housing accommodates a pump 6 for conveying liquid out from the first unit 2 and preferably a filter 5 for filtering the liquid to be conveyed so as to remove particles and/or pollutants present in the liquid 3. This filter 5 is arranged downstream the pump.

Although the term filter 5 is used hereinafter the expression is meant to comprise one or more filters and the filter or filter unit can comprise also a filter holder or the like.

Although two or more filters are suitably arranged both upstream and downstream of the pump, the liquid receptacle comprises at least one filter 5 which is preferably located downstream of the pump. The filter 5 may also be an integrated part of the pump. The mesh size of the filter 5 arranged after the pump should be adapted to fulfil the requirements on the liquid to be conveyed via the outlet conduit 7. In order to allow for cleaning the filter the pump may be reversible, whereby particles can be flushed back into the tank. The filter may be removably mounted in the second unit 1 or in the first unit 2 to enable replacement or servicing of the filter.

In the embodiment illustrated in FIG. 1 the first unit 2 contains a liquid agent 3, such as urea. Urea 3 is drawn from the space inside the first unit through a suction conduit 4 extending from the pump 6 into the first unit 2. The urea is then filtered by the filter 5 and supplied to an exhaust purifying device in a combustion system, such as an internal combustion engine (not shown), through the outlet conduit 7.

The second unit 1 can be releasably attached to the first unit 2. The second unit can be releasably attached as one single unit having the pump and filter integrated in the second unit. Alternatively, the housing of the second unit can be removed in one part or in two or more parts without removal of the pump or the filter. In such a case the pump 6 and/or the filter 5 can be releasably attached to the first unit although arranged inside the housing 61.

In one embodiment of the invention illustrated in FIG. 7 the filter 5 is removably arranged in the second unit 1 so as to enable the filter to be removed without removal of the second unit 1 from the first unit 2. One way to obtain such an arrangement is to arrange the filter in a holder 23 which holder is arranged in the second unit 1 and displaceable relative to the second unit 1 so as to enable access to the filter 5 by displacement of the holder 23. In FIG. 7 the holder 23 contains the filter 5 and the holder has been withdrawn horizontally outwards, as indicated by arrow A<|. In this position the filter 5 can be replaced by releasing the filter 5 or filter unit, and subsequent removal of the filter 5 by withdrawing the filter 5 downwards, as indicated by arrow A2.

However, as previously described the filter and/or the pump can be removably attached to the first unit 2, where access to the both components 5, 6 can be obtained by removal of parts of or the entire housing 61 of the second unit 1.

The second unit 1 can be arranged on an upper surface, preferably on the top of the first unit 2 when the liquid receptacle is installed on a vehicle. Depending on the packaging conditions in some cases the second unit 1 is more suitably arranged on a lateral surface of the first unit when the liquid receptacle is installed on a vehicle as illustrated in FIG. 5.

FIG. 7 further shows an embodiment where the first unit 2 has a protruding portion 50 and the second unit 1 has a recess 51 for receiving said protruding portion. The protruding portion can be arranged in a corner of the first unit. The external surface of the protruding portion is substantially flush with the external surface of the second unit.

As illustrated for example in FIG. 1 the second unit 1 when being attached to the first unit 2 is preferably arranged to cover an opening 52 of the first unit 2 so as to close the space of the first unit 2 relative to the environment.

In the embodiment of the liquid receptacle according to the invention illustrated in FIG. 1, the second unit comprises a device 8 for heating liquid contained in the first unit. The heating device 8 for heating the liquid

contained in the first unit comprises a heating conduit 9 and a portion of the heating conduit 9 is arranged in the space inside the first unit 2. The heating conduit 9 is arranged to transfer heat to the liquid 3 by means of a heating medium which flows inside the conduit 9. The heating medium can be coolant from an engine of a vehicle. The heating device 8 can be additionally arranged to transfer heat to the pump 6. In such a case a further portion of the heating conduit of the heating device is preferably arranged to extend close to the pump. In the same way, the heating device can be additionally arranged to transfer heat to the filter 5. In such a case a further portion of the heating conduit of the heating device is arranged to extend close to the filter. In other words, a further portion 10 of the heating conduit can be arranged to extend inside the housing 61 of the second unit 1 so as to heat the pump 6 and/or the filter 5.

Thus, in addition to the urea 3 in the first unit, the components in the second unit are also heated. The heating device 8 comprises the conduit portion 9 arranged to extend into the first unit 2 and a further conduit portion 10 arranged to first heat the pump 6 and then the filter 5. The coolant from the coolant circuit is supplied from an inlet conduit 11 and discharged by an outlet conduit 12. In this particular example the heating device 8, the suction conduit 4, the filter 5 and the pump 6 are integrated component parts of the second unit 1.

As already described above, the heating device may preferably comprise a heating conduit and a portion of the heating conduit is arranged in the space inside the first unit so as to transfer heat to the liquid contained in the first unit. Although an electrical heating device could be used, a heating conduit which is arranged to transfer heat to the liquid by means of a heating medium which flows inside the heating conduit is preferred. It is effective to use for example the coolant from an engine of a vehicle as the heating medium in the heating device. The engine coolant may comprise a mixture of water and an anti-freeze, such as glycol. Depending on the percentage of anti-freeze therein, the engine coolant may withstand temperatures of −500C or lower.

Suitably, a conduit for supplying the heating device with engine coolant may be branched off a coolant circuit for a combustion system, such as an internal combustion engine, upstream of for example a radiator or some other suitable heat exchanger.

The second unit 1 may also comprise electrical equipment, such as an electrical control unit for operating the pump.

Furthermore, the first unit 2 providing the space for the liquid can be thermally insulated to prevent the liquid present in the first unit from freezing after short operating shutdowns, which otherwise could occur in case of low temperatures.

The housing 61 of the second unit 1 can be provided with insulated walls to maintain the temperature as high as possible inside the housing. Suitably the walls which are arranged to be faced away from the first unit are insulated to prevent or decrease heat transfer to the environment, whereas any wall facing the first unit is not insulated to allow heat to be transferred from the first unit to the components arranged inside the housing of the second unit.

The upper section or a lateral section of the first unit 2 can be provided with said opening 52 for receiving said portion of the heating conduit and also the suction conduit of the pump. The pump has preferably such a suction conduit 4 which extends into the interior of the first unit 2 to a position which ensures the liquid can be conveyed out from the first unit. Suitably, the portion of the heating conduit which is arranged in the space inside the first unit 2 extends adjacent to a position where the liquid to be conveyed out from the first unit enters the suction conduit of the pump. More preferably, the portion of the heating conduit which is arranged in the space inside the first unit extends substantially along the extension of the suction conduit 4 of the pump 6.

A filler opening for filling the first unit 2 with liquid may be provided at a separate location on the first unit, or at a position inside the housing 61 of the second unit. In the latter case, an integrated filler opening may pass through the second unit, either into a separate opening in the upper part of the tank or into the same opening 52 used for the heating conduit portion and/or the suction conduit. Alternatively, if the second unit is attached to a side portion of the first unit, the upper part of the side portion of the first unit can be provided with one single or two separate openings for the conduit portion and the suction conduit. If a side mounted second unit is used, the filler opening may be provided at a separate location in an upper surface of the first unit. Suitable sealing means can be provided between the opening or openings of the first unit and the components connected to the first unit.

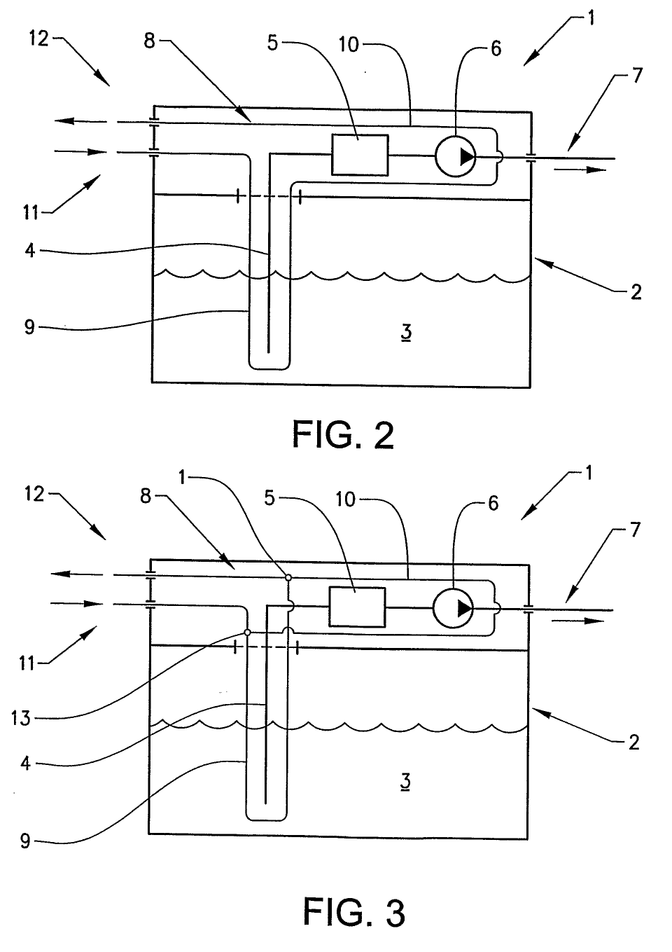

As illustrated in FIG. 2 the conduit portions for heating the liquid 3 and the pump 6 can be connected in series. In this embodiment the heating medium may first flow into the conduit portion for heating the liquid in the first unit and then into a further portion for heating the pump and/or any associated components, such as the filter. The heating medium may then be returned to the source, for example the coolant circuit of the engine. The flow of the heating medium may of course be selected to run in either direction and may be directed to each component in turn depending on the heating requirements for the individual components. The heating process may also be regulated by means of a controllable valve that may be switched on/off, pulsed or otherwise controlled to provide a predetermined flow rate.

As illustrated in FIG. 3 the conduit portions for heating the liquid 3 and the pump 6 can be connected in parallel. In this embodiment the heating medium may be divided into a first flow to the conduit portion 9 for heating the liquid 3 in the first unit 2 and a second flow to the further conduit portion 10 for heating the pump 6 and/or any associated components. As in the previous embodiment, the direction of flow may be selected depending on the heating requirements for the individual components. The heating process may also be controlled by means of a controllable valve that may be switched on/off, pulsed or otherwise controlled to provide a predetermined flow rate. Suitable flow rates for different heating requirements in the respective sections may be accommodated by selecting a suitable cross-sectional area for each conduit portion, and/or by providing at least one additional controllable valve for one or both conduit portion.

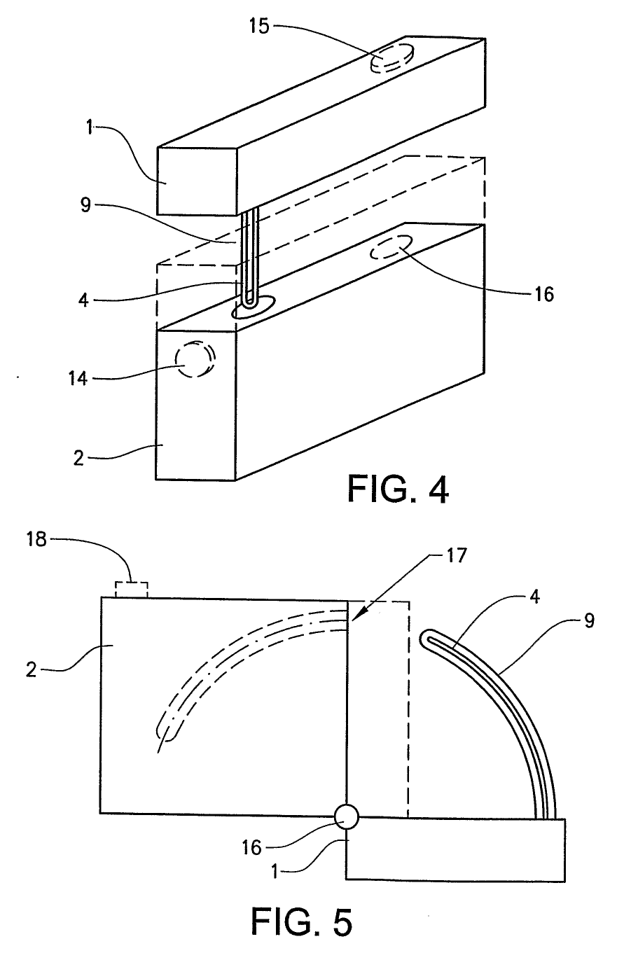

FIG. 4 shows liquid receptacle where the second unit 1 is mounted on the upper side of the first unit 2. The first unit 2 and/or second unit 1 can be provided with attachment means, such as clips or the like, that can be released to allow the units to be separated from each other. A filler tube for urea can be provided either on the first unit 2 (indicated by 14) or on the second unit 1 (indicated by 15). In the latter case, the filler tube 15 extends through the second unit 1 and into an opening 16 in the upper surface of the first unit 2.

As illustrated in FIG. 5 the first unit and the second unit can be pivotally connected to each other. Alternatively the housing or a portion thereof of the second unit is pivotally connected to the first unit. In the first case the entire second unit comprising the suction conduit 4, the heating conduit portion 9, the pump and the filter, is releasable from the first unit 1 as an integral unit. In the second case only the housing or portions thereof is releasable from the first unit, and the respective component is instead releasably arranged in the first unit 2. In both cases the second unit/housing of the second unit can be provided with attachment means, such as clips (not shown), that can be released to allow the unit/housing to be released. In the embodiment illustrated in FIG. 5 the second unit is pivoted around a hinge 16 located along the short side edge of a lower corner of the first unit 2. In order to allow the suction conduit 4 and the conduit portion 9 of the heating device to be withdrawn from the first unit, both components have a shape curved along a constant radius with respect to the hinge 16. This allows the suction conduit 4 and the conduit portion 9 to pass through an opening 17 adjacent the upper end of the side surface of the first unit. A filler tube 18 for urea can be provided on top of the first unit 2.

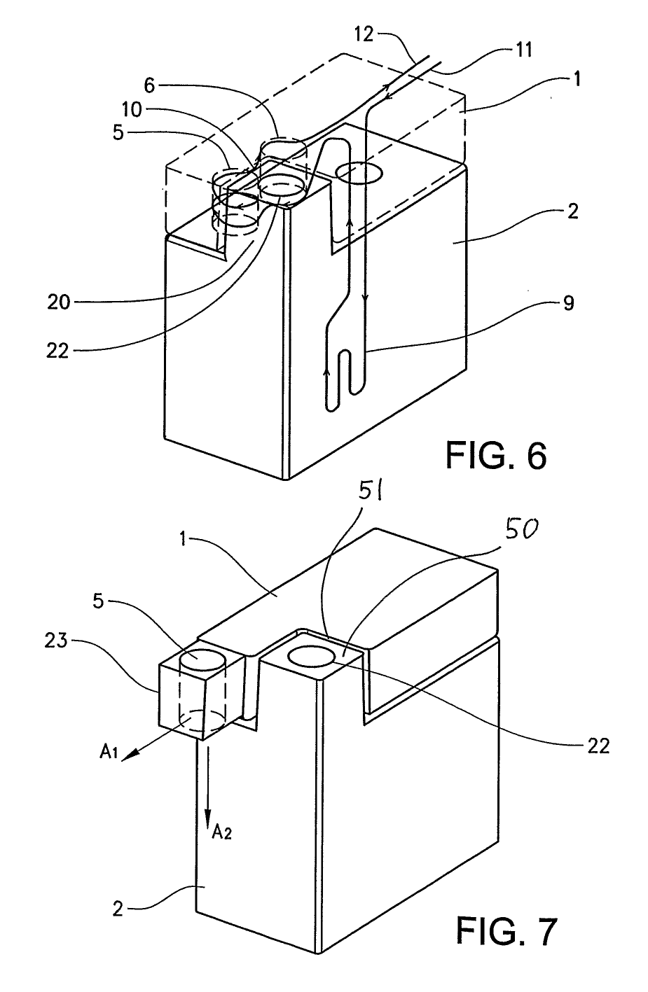

FIG. 6 shows an alternative arrangement where a corner section 20 of the first unit 2 extends upwards from the main body of the tank 2, so that the upper surface of this corner 20 is substantially flush with the upper surface of the second unit 1 (indicated with dashed lines). A filler tube is arranged in the upper surface of the corner 20. The figure also indicates the position of the first conduit portion of the heating device passing through an opening 22 in the first unit 2 and the arrangement of the further conduit portion 10 which passes the filter unit 5 and the pump 6 (indicated with dashed lines).

The liquid receptacle itself may be positioned on one of the longitudinal main beams making up the frame of a vehicle. By locating the liquid receptacle adjacent a component that gives off heat when the vehicle is running, such as an exhaust silencer, additional heating may be provided. In fact, the liquid receptacle may be located in a number of alternative positions that traditionally are not used for liquid receptacles of this type. For instance, the liquid receptacle may be mounted on the rear wall of a vehicle cab. The freedom to arrange the liquid receptacle in various positions can also contribute to keeping the hoses for supplying the liquid agent to the liquid receptacle and further to the combustion system as short as possible.

FIG. 8 shows a heavy vehicle 25 provided with a liquid receptacle according to the invention, In this example, the liquid receptacle is mounted on a frame 26 adjacent an exhaust silencer 27 of the vehicle. By mounting the apparatus adjacent a component that is giving off heat when the vehicle is operated, the pump and the filter located in the second unit and the liquid in the first unit can be heated by this component alone or in combination with a heating device using the coolant from the engine, when the vehicle is running.

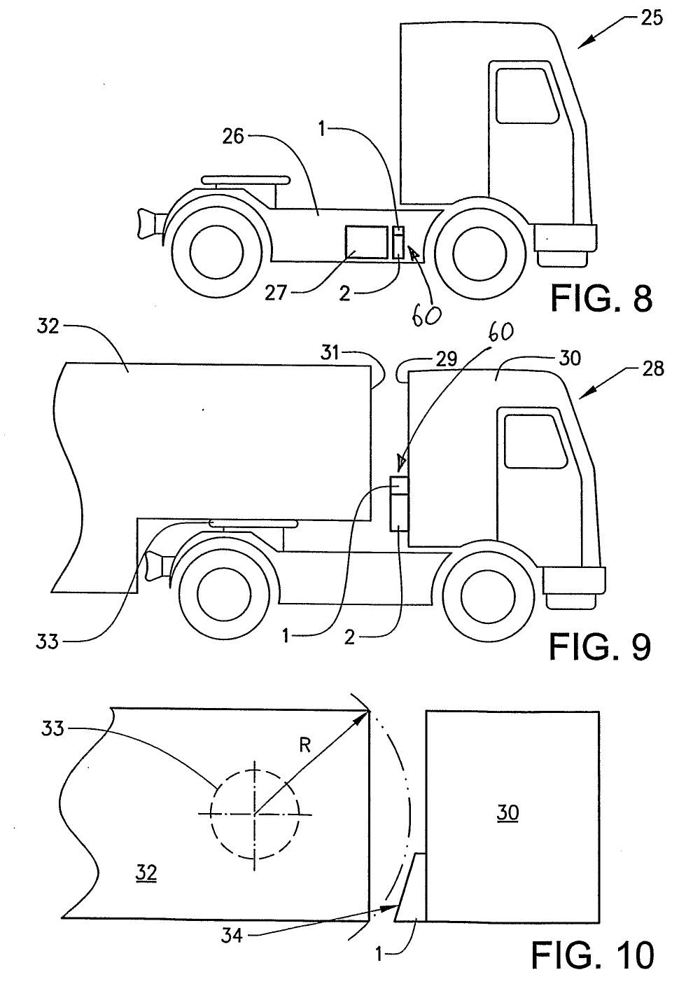

FIG. 9 shows a heavy vehicle provided with a liquid receptacle 60 according to the invention. The liquid receptacle is mounted on a drivers cab 30, between a rear wall 29 of the cab 30 and the front end wall 31 of a trailer 32 which is connected to the tractor by a fifth wheel coupling 33 on the tractor 28. This arrangement solves a packaging problem and allows the space between the tractor and trailer to be more effectively utilized. FIG. 10 shows a plan view of the tractor-trailer combination of FIG. 9. This figure shows that the rear surface 34 of the liquid receptacle has been given an angled shape adapted to the available space and the turning radius R defining the path which is followed by the front corners of the trailer (indicated in dashed lines) as the trailer 32 is pivoted around the fifth wheel coupling 33. This arrangement allows the liquid receptacle to be arranged behind the cab 30 even in the case the available space is relatively limited.

The heating device is mainly intended for heating the liquid and/or the pump and the filter during freezing conditions, such as during a cold start of a combustion system in sub-zero conditions. However, it may also be possible to heat the liquid and any associated component at any time during operation of the combustion system, in response to changes in the ambient temperature. The supply of liquid heating medium, such as engine coolant, may be switched on or off by means of a controllable valve in the conduit for the liquid heating medium. The controllable valve may be an electrically controlled solenoid valve.

The controllable valve can be connected to an electronic control unit (ECU) that may be arranged to open and close the valve in response to one or more sensed conditions. Examples of such conditions may be the temperature of the liquid in the first unit, the temperature of liquid heating medium, the ambient temperature and/or the filling level of the first unit.

It is to be understood that the present invention is not limited to the embodiments described above and illustrated in the drawings; rather, the skilled person will recognize that many changes and modifications may be made within the scope of the appended claims.

1. A liquid receptacle for a vehicle, comprising a first unit having a space for containing a liquid and a second unit which is attached to the first unit, wherein the second unit firstly comprises a housing which housing accommodates a pump for conveying liquid out from the first unit and secondly comprises a device for heating liquid contained in the first unit wherein the heating device comprises a heating conduit and a portion of the heating conduit is arranged in the space inside the first unit, wherein a further portion of the heating conduit is arranged to extend inside the housing so as to heat a component which is accommodated in the housing.

2. A liquid receptacle for a vehicle, comprising a first unit having a space for containing a liquid and a second unit which is attached to the first unit, wherein the second unit comprises a housing which housing accommodates a pump for conveying liquid out from the first unit, wherein the second unit when being attached to the first unit is arranged to cover an opening of the first unit so as to close the space of the first unit relative to the environment.

3. A liquid receptacle for a vehicle, comprising a first unit having a space for containing a liquid and a second unit which is attached to the first unit, wherein the second unit firstly comprises a housing which housing accommodates a pump for conveying liquid out from the first unit and which pump has a suction conduit which extends into the interior of the first unit and secondly the second unit comprises a device for heating liquid contained in the first unit wherein the heating device comprises a heating conduit and a portion of the heating conduit is arranged in the space inside the first unit, wherein the portion of the heating conduit which is arranged in the space inside the first unit extends adjacent to a position where the liquid to be conveyed out from the first unit enters the suction conduit of the pump.

4. A liquid receptacle for a vehicle, comprising a first unit having a space for containing a liquid and a second unit which is attached to the first unit, wherein the second unit firstly comprises a housing which housing accommodates a pump for conveying liquid out from the first unit and which pump has a suction conduit which extends into the interior of the first unit and secondly the second unit comprises a device for heating liquid contained in the first unit wherein the heating device comprises a heating conduit and a portion of the heating conduit is arranged in the space inside the first unit, wherein the portion of the heating conduit which is arranged in the space inside the first unit extends substantially along the extension of the suction conduit of the pump.

5. A liquid receptacle according to claim 1, wherein the housing of the second unit accommodates a filter for filtering the liquid to be conveyed.

6. A liquid receptacle according to claim 5 wherein the filter is removably arranged in the second unit so as to enable the filter to be removed without removal of the second unit from the first unit.

7. A liquid receptacle according to claim 6, wherein the filter is arranged in a holder which holder is arranged in the second unit and displaceable relative to the second unit so as to enable access to the filter therein.

8. A liquid receptacle according to claim 7, wherein the filter is removably attached to the first unit.

9. A liquid receptacle according to claim 1, wherein the first unit and the second unit are pivotally connected to each other.

10. A liquid receptacle according to claim 1, wherein the first unit has a protruding portion and the second unit has a recess for receiving protruding portion.

11. A liquid receptacle according to claim 10, wherein the protruding portion is arranged in a corner of the first unit.

12. A liquid receptacle according to claim 10, wherein the external surface of the protruding portion is substantially flush with the external surface of the second unit.

13. A liquid receptacle according to claim 1, wherein the second unit comprises an electrical control unit for operating the pump.

14. A heavy vehicle provided with a liquid receptacle according to claim 1.

15. A liquid receptacle according to claim 2, wherein the first unit and the second unit are pivotally connected to each other.

16. A liquid receptacle according to claim 2, wherein the first unit has a protruding portion and the second unit has a recess for receiving protruding portion.

17. A liquid receptacle according to claim 3, wherein the first unit and the second unit are pivotally connected to each other.

18. A liquid receptacle according to claim 3, wherein the first unit has a protruding portion and the second unit has a recess for receiving protruding portion.

19. A liquid receptacle according to claim 4, wherein the first unit and the second unit are pivotally connected to each other.

20. A liquid receptacle according to claim 4, wherein the first unit has a protruding portion and the second unit has a recess for receiving protruding portion.
